(19) United States
(12) Patent Application Publication
(10) Pub. No.: US 2018/0265341 A1
(43) Pub. Date: Sep. 20, 2018

(54) ELECTRIC CAN OPENER WITH ROTATING SPHERICAL JOINT

(71) Applicant: Gregory Mark Adamczak, Stamford, CT (US)

(72) Inventor: Gregory Mark Adamczak, Stamford, CT (US)

(21) Appl. No.: 15/462,364

(22) Filed: Mar. 17, 2017

(51) Int. Cl. B67B 7/00

(52) U.S. Cl. CPC B67B 7/385

(57) ABSTRACT

An electric can opener with rotating spherical joint for removal a lid from a can is provided. The rotation of motorized driver in a helical cam moves readily a cutting blade toward a transport wheel to engage the end of the can, so that it is in the proper condition to cut end from the can. Further rotation of the transport wheel, forces the can against the blade to cut the end of the can.

### BACKGROUND OF THE INVENTION

### (1) Field of the Invention

The present invention relates generally to a can opener. Specifically, the present invention relates to an electric operated can opener to satisfy an ambidextrous, senior user and to be ergonomically friendly.

The present invention of an electric can opener is suited for opening the lid from any size and any shape of the can.

The present invention of the electric can opener offers a simplified design and maximizes operational performance.

### (2) Description of Related Art Including Information Disclosed Under 37 CFR 1.97 and 1.98

In general, an electric can opener consists of a housing, which is fitted with a cutting blade for removal the lid from a can, a transport wheel for rotating the can relative to the cutting blade, and a mechanism for rotating the transport wheel. Most that are portable include batteries for the powering an electric motor and a battery charger.

A process for constant battery charge is necessary to provide the proper electricity level in the battery. Such a process raises the concern of battery life storage and can opener operational readiness.

The battery operated portable electric and free-standing can openers are mostly useful for use on small and medium size cylindrical cans, but they have operational limitations for their use on large and non cylindrical shaped cans.

Accordingly, there is a need for an improved electric can opener, whose the principle operational mechanism is as disclosed by commonly owned U.S. Pat. No. 6,119,352.

### BRIEF SUMMARY OF THE INVENTION

One aspect of the present invention resides in an electric can opener for removal a lid from a can, to satisfy an ambidextrous and senior user.

Another aspect resides in an electric can opener in which the operational process is facilitated by the electric AC voltage motor.

A further aspect resides in an electric can opener for removal of a lid from a can of any size and any shape.

An additional aspect resides in an electric can opener whose operational elements form a spherical joint assembly.

Still another aspect resides in an electric can opener with a cam for the operational engagement with to motorized driver and a blade holder to facilitate the tilt and the rotating motion with the spherical joint assembly.

Yet another aspect resides in an electric can opener in which the rotation of the motorized driver automatically moves a cutting blade and a transport wheel into the proper position to cut the can. Further rotation of the transport wheel forces the can against the cutting blade to cut the end, such as a top, from the can.

A further additional resides in an electrical can opener with a simplified design, and with an agronomical shape of the housing, for providing a user-friendly grip by senior user.

### BRIEF DESCRIPTION OF THE SEVERAL VIEWS OF THE DRAWING(S)

Exemplary embodiments of the present invention may be further understood with reference of the appended drawings listed as follows and their subsequent related description.

FIG. 1 is a sectional view of the electric can opener of the present invention and taken across section line 1,3-1,3 of FIG. 2.

FIG. 2 is a side view of the electric can opener of FIG. 1.

FIG. 3 is a sectional view of the electric can opener of FIG. 1 shown in an operational position in which a can has been inserted and taken across section line 1,3-1,3 of FIG. 2.

FIG. 4 is a front view of the driver.

FIG. 5 is a front view of the blade holder.

FIG. 6 is a front view of the cam.

FIG. 7 is a sectional view of the cam of FIG. 6 and taken across section line 7-7 of FIG. 6.

### DETAILED DESCRIPTION OF THE INVENTION

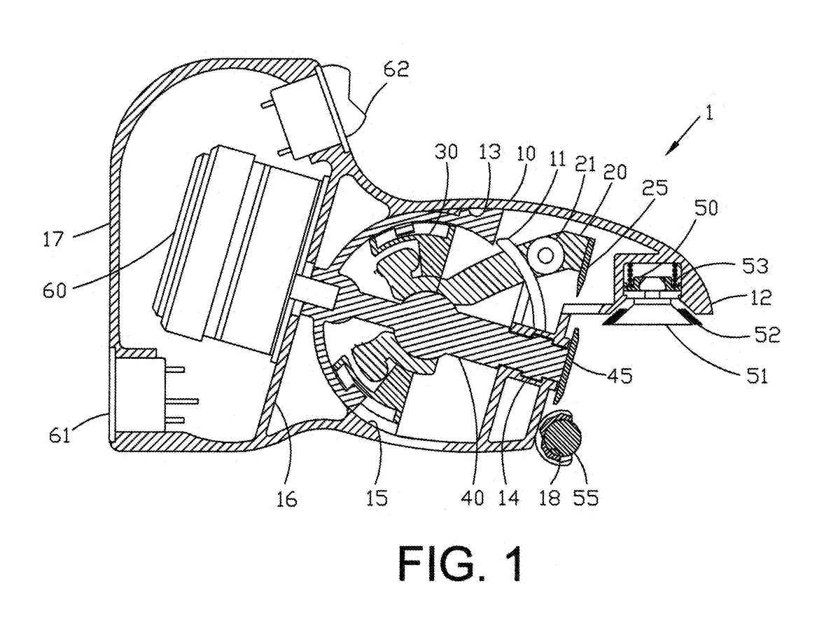

Referring to the figure FIG. 1, the electric can opener 1 is provided. The electric can opener 1 includes a housing 10, a motor 60, a reversible switch 62, an electrical plug 61, a driver 40, a cam 30, a blade holder 20, a roller 21, a transport wheel 45, a cutting blade 25, a suction cup 51, a magnet 52, a suction cup holder 50, a spring 53, and a spherical can roller 55.

As shown on FIG. 1, the housing 10 of the electric can opener 1 has a sectional oval shape, with an inner spherical surface 15 connected with a partially cylindrical surface 17. The housing includes a hood 12, a sidewall 13, a mounting plate 16, a bearing 14, a roller track 11, and a spherical nest 18 for the spherical can roller 55.

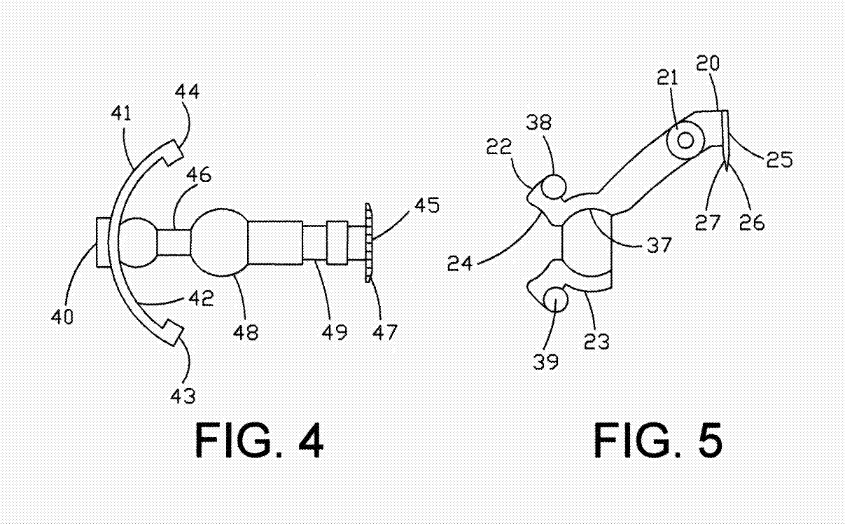

As shown on FIGS. 1, 3, 4 and 5, the driver 40 includes an outer convex surface 41 and an inner convex surface 42 with a shaft 46 that protrudes centrally inward from the inner convex surface 42 for the engagement with the transport wheel 45. The driver 40 further includes cam followers 43 and 44, which are configured to engage with helical slot 32 of the cam 30. The shaft 46 has a shoulder 49 and outer convex surfaces 48 to fit the inner concave surface 37 of the blade holder 20.

As shown on FIGS. 1, 3 and 5, the blade holder 20 has an outer convex surface 22, 37 and an inner concave surfaces 24, 37. The blade holder 20 is configured to attach the cutting blade 25. The same end has the roller 21 to accommodate with the roller track 11 for the radial rotation alignment so that the cutting blade 25 is adjacent the transport wheel 45. The other end of the blade holder 20 has set of selector guides 38 and 39 to engage with a conical surface 35 of the cam 30.

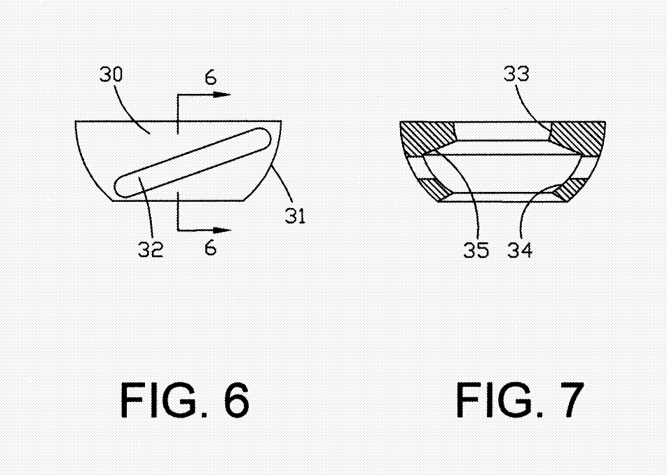

As shown on FIGS. 1, 3, 6 and 7, the cam 30 has an outer convex surface 31, inner convex surfaces 33, 34 and an inner conical surface 35. The cam 30 has a helical slot 32 for engagement with the cam follower 43 or 44 of the driver 40. Further, the cam 30 is mounted concentrically for tilt and rotates with the driver 40 and the blade holder 20.

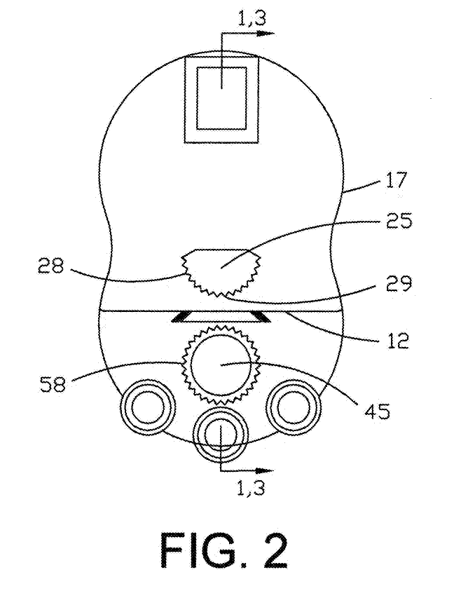

As shown in FIGS. 1-7, the blade holder 20 has an inner convex surface 37 that rests upon an outer convex surface 48 of the driver 40. The blade holder 20 thus tilts in the spherical joint formed by contact of the outer convex surface of the driver 40, inner spherical surfaces 23, 37, the conical surface 35 of the cam 30 and the convex surface 33 of the cam 30, such that the cutting blade 25 moves toward the transport wheel 45 in one direction. Tilting of the blade holder 20 in the other direction brings the cutting blade 25 above the transport wheel 45.

As shown on FIGS. 1-3 and 5, the cutting blade 25 is shaped as a circular blade, with surfaces 26 and 27 tapering in and joining at cutting teeth 28. The cutting teeth 28 are equally spaced and arrayed in semi-circumference. A middle tooth 29 is located centrally of the semi-circumference of cutting teeth 28. The cutting blade 25 is configured to pierce the top of a lid 77 of a can 75 with middle tooth 29 and/or adjacent cutting teeth 28.

As shown on FIGS. 1-4, a transport wheel 45 is in the form of circular blade with equally spaced teeth 58 and a surface 47 that tapers toward the edge. The transport wheel 45 is configured to be engaged under a rim 76 of the can 75.

As shown in FIGS. 1-3, the can rim 76 rests on the transport wheel 45. The spherical can roller 55 and the magnet 52, with the suction cup 51 and spring 53, hold down a can 75 into position to be pierced or cut by the cutting blade 25. The hood 12 projects downward from above the cutting blade 25 and has contact with the can rim 75 during operation of the can opener 1. The hood 12 houses the suction cup 51, the suction cup holder 50, a spring 53 and a magnet 52. The suction cup 51 is positioned to latch onto the lid 77 of the can 75 when the can is in position to be cut.

Upon a can insertion into the electric can opener 1, the lid 77 is pressed against the suction cup 51 and the magnet 52. The transport wheel 45 is also pressed against the bottom of the can rim 76, thus securing the can 75 for an operation. The cutting blade 25 is then operated with transport wheel 3 to cut the lid 77 from the can 75. Suction cup 51 and/or magnet 70 holds lid 77 after the lid 77 is cut from the can 75.

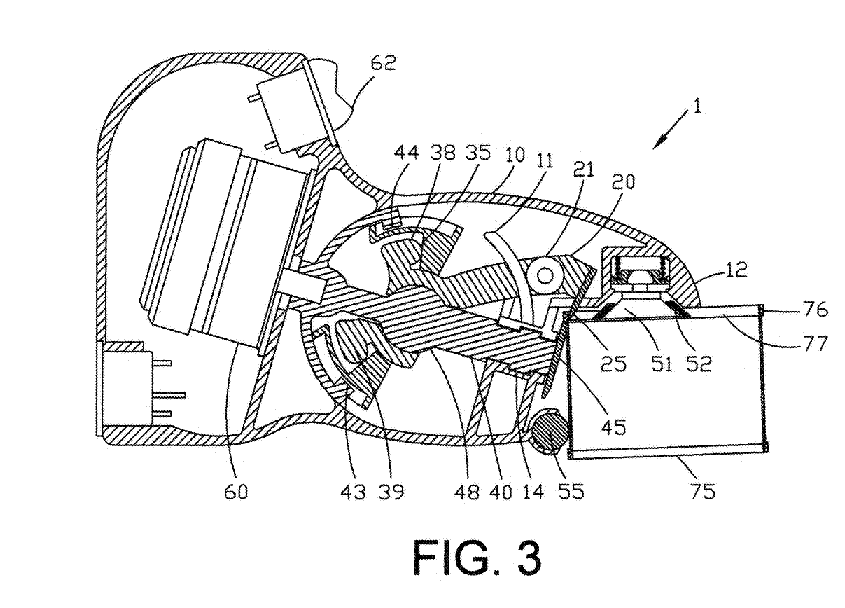

As shown on FIG. 3, the electrical can opener 1, when in the operational cutting mode and as the motor 60 rotates the driver 40, has components that effect the following:

[a] the cam follower 43, 44 slides in the helical slot 32 and forms the engagement of the driver 40 and the cam 30;

[b] the roller 21 rotates around the roller track 11;

[c] the selector guides 29 and 30, resting upon on the inner conical surface 34, pushes/rotates down the cam 30;

[d] the selector guides 29 and 30 slides simultaneously on the inner conical surface 34 and tilts blade holder 20 around the convex surface 48 in a direction downward to the can 75; and

[e] the blade cutter 25, attached to the blade holder 20, contacts the can lid 77.

As the blade holder 20 is tilted further:

[f] the blade cutter 25 moves in the downward direction to pierce the top of the lid 77.

As shown on FIG. 3, in the cutting operational mode of the can opener 1, which as an assembly is constituted by the motor 60, the driver 40 and the cam 30, the following ensues:

[a] the cam 30 rotates in an outer concave surface 23 of the blade holder 20;

[b] the cam 30 has an inner conical surface 35 that rotates on a convex surface of the selector guides 29 and 30;

[c] the cam followers 43 and 44 slide on the side surface of the declined or helical slot 32 to create a dragging force in the cam 30;

[f] the driver 40, as a part of the partial spherical joint, rotates in the inner blade surface 28 of the blade holder 20, and in the bearing 14 of the housing 10;

[g] the selector guides 29 and 30 rotate in the inner conical surface 34 of the cam 30;

[h] the transport wheel 45, which is attached to the driver 40, rotates around under the rim 76 of the can 75; and

[i] the cutting blade 25 cuts the lid 77 until completing a full circle.

During the cutting process of the can 75, the position of the cutting blade 25 is maintained by the constant dragging force that is exerted on the spherical surface 48 of the driver 40 by sliding in the helical slot 32 of the cam 30. Upon completion of the cutting, the cutting blade 25 disengages from the top of the can 75, and the cut lid 77 disengages the transport wheel 45 by switching the rotating of the driver 40 in direction opposite to the cutting direction. The cut lid 77 is lifted by the suction cup 51 and the magnet 52.

It should be understood that foregoing description is only illustrative of the invention. Various alternatives and modifications can be devised by those skilled in the art without departing from the invention. Accordingly, the present invention is intended to encompass all such alternatives, modifications and variances that fall within the scope of appended claims.

1-11. (canceled)

12: An electric can opener for cutting an end of can, comprising:
a housing;
a cam;
a driver operatively connected to the cam to drive the cam;
a cutting blade;
a blade holder holding the cutting blade and operatively connected to the cam, the cam having a conical surface that slides and rotates on the blade holder as the cam is driven by the driver;
an electric motor operatively connected to the driver to rotate the driver; and
means for rotating the side wall of the can so that a cutting blade held by the blade holder cuts a lid of the can.

13. (canceled)

14: The electric can opener of claim 12, wherein the driver has cam followers that engage with cam slots.

15: The electric can opener of claim 12, wherein the blade holder has a set of selector guides that slide over the conical surface of the cam.

16: The electric can opener of claim 12, wherein the cam has an inner conical surface and has an inner concavely curved surface that extends from the inner conical surface.

17: The electric can opener of claim 15, wherein the driver cam followers simultaneously slide in the cam slots to contact one of the selector guides with a conical surface of the cam to facilitate operational movement to rotate the driver and to tilt blade holder.

18: The electric can opener of claim 12, wherein the housing has a spherical nest that provides bearing surface for the spherical guide to facilitate rotative movement of the side wall of the can.

19: The electric can opener of claim 14, further comprising:
a transport wheel, the driver being configured to drive the transport wheel;
a cutting blade held by the blade holder, the blade holder being operatively connected to the cam for tilt and rotation, the cam having a conical surface that slides and rotates on the blade holder; and
a can roller that assists in tilting of a can into position to be pierced or cut by the cutting blade during operation.

20-22. (canceled)

23: The electric can opener of claim 19, wherein the blade holder is configured to tile on a convexly curved surface of the driver.

24: The electric can opener of claim 19, wherein the driver is arranged so that:
rotation of the driver causes the cam followers to move in the slots of the cam, which causes tilting of the blade holder downward to the transport wheel; and
further rotation of the driver causes the transport wheel to engage a can rim and causes the cutting blade to engage a lid of the can.

25: The electric can opener of claim 22, wherein the further rotation of the driver causes the cutting blade to cut the lid of the can.

26. (canceled)
